(19) United States
(12) Patent Application Publication
(10) Pub. No.: US 2010/0024225 A1
(43) Pub. Date: Feb. 4, 2010

(54) BAND SAW BLADE

(76) Inventor: Jeffrey M. Wackwitz, Menomonee Falls, WI (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/511,143

(22) Filed: Jul. 29, 2009

Related U.S. Application Data
(60) Provisional application No. 61/085,740, filed on Aug. 1, 2008.

(51) Int. Cl. B23D 53/12; B23D 55/06

(52) U.S. Cl. 30/380; 83/661

(57) ABSTRACT

A band saw including a housing, a motor supported by the housing, a first wheel supported by the housing for rotation about a first wheel axis, the first wheel being drivingly coupled to the motor and driveable by the motor, and a second wheel supported by the housing for rotation about a second wheel axis. A band saw blade extends around the first wheel and the second wheel for traveling in a continuous loop around the first wheel and the second wheel to cut a work piece. The band saw blade includes a first surface for engaging the first wheel and the second wheel, and a second surface opposite the first surface. The first surface includes a knurled surface for gripping the first wheel and the second wheel.

### RELATED APPLICATIONS

This application claims priority to co-pending U.S. Provisional Patent Application Ser. No. 61/085,740 filed on Aug. 1, 2008, the entire contents of which are incorporated herein by reference.

### BACKGROUND

The present invention relates to power tools, and more particularly to band saws.

A band saw includes a band saw blade rotatably mounted about two wheels to effect a cutting action on a work piece. The tension created by looping the band saw blade about the two wheels provides that the band saw blade will remain in place between the two wheels.

### SUMMARY

In one embodiment, the invention provides a band saw. The band saw includes a housing, a motor supported by the housing, a first wheel supported by the housing for rotation about a first wheel axis, the first wheel being drivingly coupled to the motor and driveable by the motor, and a second wheel supported by the housing for rotation about a second wheel axis. A band saw blade extends around the first wheel and the second wheel for traveling in a continuous loop around the first wheel and the second wheel to cut a work piece. The band saw blade includes a first surface for engaging the first wheel and the second wheel, and a second surface opposite the first surface. The first surface includes a knurled surface for gripping the first wheel and the second wheel.

Other aspects of the invention will become apparent by consideration of the detailed description and accompanying drawings.

### BRIEF DESCRIPTION OF THE DRAWINGS

FIG. 1 is a side perspective view of a band saw including a band saw blade according to one embodiment of the invention.

FIG. 2 is a bottom perspective view of the band saw of FIG. 1.

FIG. 3 is a detailed view of the band saw blade of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting.

### DETAILED DESCRIPTION

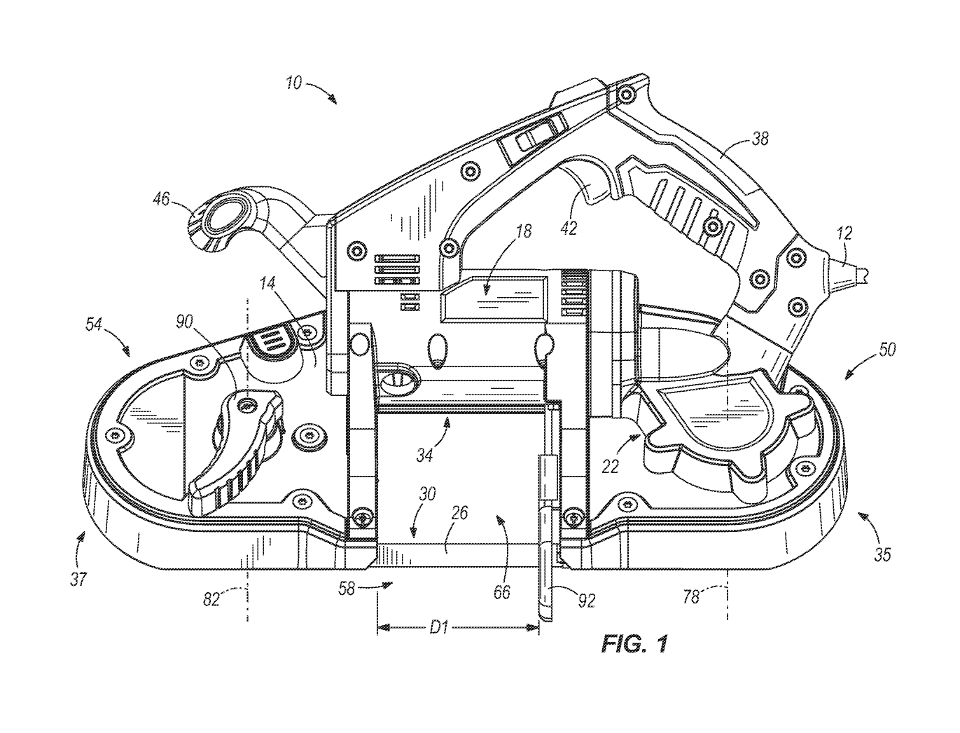

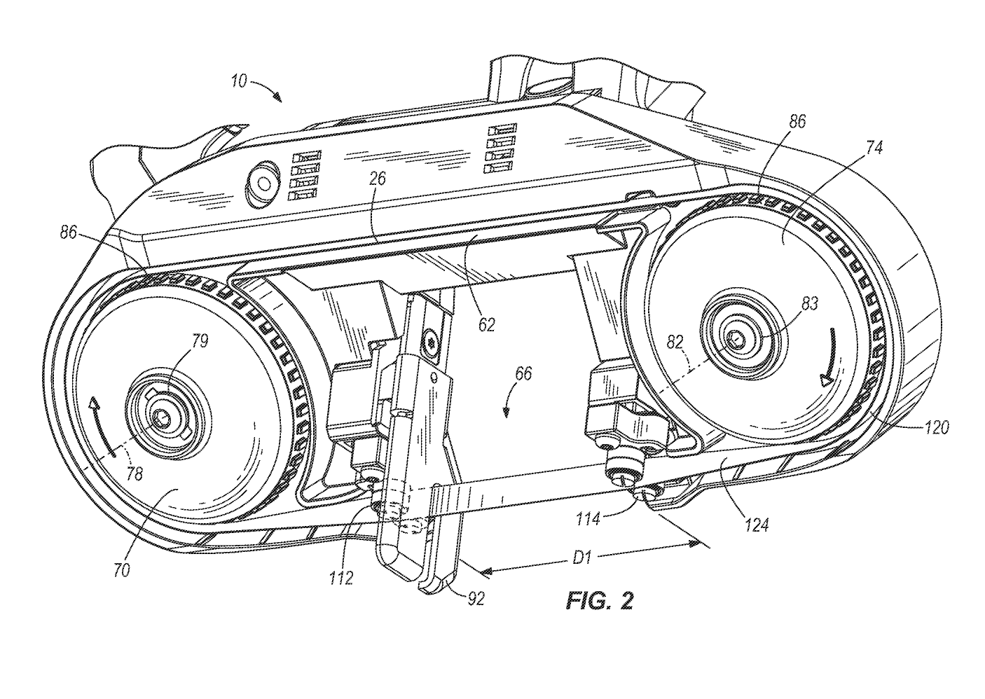

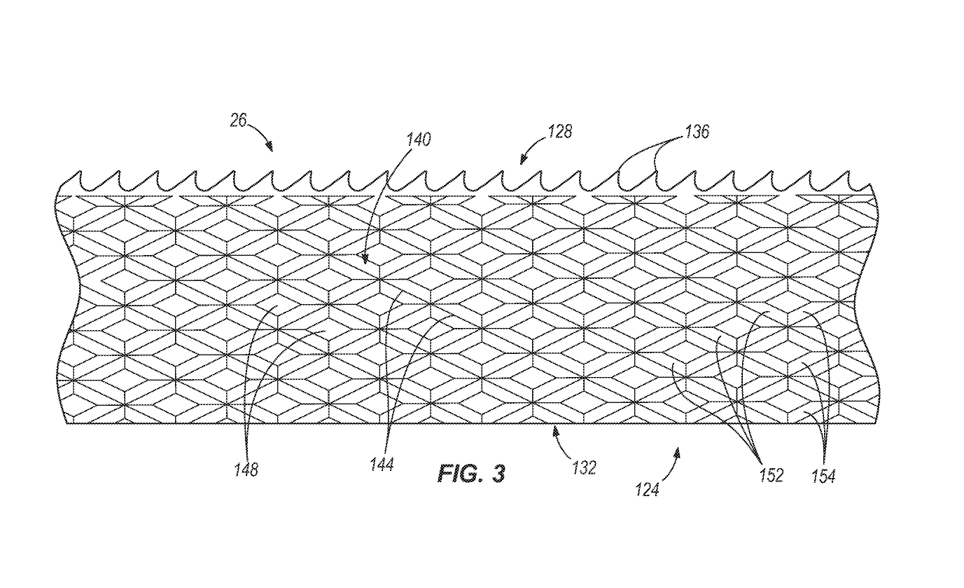

FIGS. 1-2 illustrate a band saw 10 embodying some aspects of the invention. FIG. 3 is a detailed view of a band saw blade 26 of the band saw 10 of FIGS. 1-2. Although the band saw 10 is shown as an AC-version, in further embodiments the band saw may be powered by other sources, such as a battery, a battery pack, and the like.

With reference to FIGS. 1 and 2, the band saw 10 includes a housing or frame 14 supporting a motor 18 and a gear box 22. The motor 18 is drivingly connected to a drive mechanism (not shown) at least partially housed within the gear box 22. The motor 18 and the drive mechanism are operable to drive a continuous band saw blade 26 to cut a work piece. As described herein, the band saw 10 includes a front 30 and a rear 34, as shown in FIGS. 1 and 2. The front 30 is defined as the side being proximate the portion of the band saw blade 26 that cuts the work piece and the rear 34 is defined as the side proximate the portion of the band saw blade 26 that does not cut the work piece. The rear 34 is otherwise described as being opposite the front 30.

The housing 14 includes a main handle 38 supporting a switch assembly 42 to provide power to the band saw 10. The switch assembly 42 is operable to control operation of the motor 18. The band saw 10 also includes an auxiliary handle 46 for a user's other hand. Generally, the handles 38, 46 are shaped and arranged for two-handed operation of the band saw 10 as the work piece is cut. In the illustrated construction, each handle 38, 46 has an ergonomic design to provide comfortable gripping and controlled operation of the band saw. The ergonomic design of each handle and of the combination of the handles may include the orientation or angle of handle(s). The ergonomic design may also include the use of material, such as an elastomeric material, on the handle(s) to, one or more of, provide an improved grip surface, isolate vibration and impacts from the operator, prevent heat build-up and/or transfer to the operator, etc.

The housing 14 defines a first portion 50 and a second portion 54. The first portion 50 and the second portion 54 are spaced apart from one another and define a U-shaped cavity 66 defining a cut zone 58 therebetween. A blade guard 62 (FIG. 2) is positioned at the rear 34 of the band saw 10 and extends between the first and second portions 50, 54 within the cut zone 58. The blade guard 62 provides a recessed area to house the band saw blade 26.

As shown in FIG. 2, the drive mechanism generally includes a drive wheel pulley 70 and a driven wheel pulley 74. The drive wheel 70 rotates about a drive wheel axis 78 defined by a drive wheel axle 79 and is drivingly connected to the motor 18 via a drive train (not shown). The driven wheel 74 rotates about a driven wheel axis 82 defined by a driven wheel axle 83 and is rotatably supported by the housing 14. The drive wheel 70 is positioned in the first portion 50 of the housing 14, and the driven wheel 74 is positioned in the second portion 54 of the housing 14. A wheel tire 86 is coupled to each of the peripheries of the drive wheel 70 and the driven wheel 74. Each blade tire 86 is a circular-shaped ring formed of a soft and/or flexible elastomeric material that is able to lock or adhere to the respective wheel 70, 74. The band saw blade 26 extends in a continuous loop around an outer circumferential surface of the drive wheel 70 and an outer circumferential surface of the driven wheel 74 and grips the blade tires 86 and, as a result, motion from the drive wheel 70 is transmitted to the band saw blade 26 via the blade tires 86. The band saw includes a blade tensioning mechanism 90 to adjustably provide appropriate tension on the band saw blade 26 and a shoe 92 for positioning against the work piece.

A first guide roller set 112 and a second guide roller set 114 are disposed on each side of the cavity 66 and engage opposing sides of the saw blade 26. The first and second guide roller sets 112, 114 support the band saw blade 26 as the blade 26 enters and exits the cut zone 58. The cut zone 58 is defined by the distance D1 between the shoe 92 and the second guide roller set 114.

As shown in FIG. 2, the band saw blade 26 includes an outer surface 120 and an inner surface 124. The inner surface 124 contacts the wheel tires 86 of the drive wheel 70 and the driven wheel 74 during operation of the band saw 10 and rotation of the band saw blade 26. The outer surface 120 is generally opposite the inner surface 124. The band saw blade 24 also includes a cut edge 128 and a non-cut edge 132 (FIG. 3). The cut edge 128 includes saw teeth 136 configured to cut the work piece, and the non-cut edge 132 is generally opposite the cut edge 128. The saw teeth 136 may have any shape or orientation to effect a cutting action.

As shown in FIG. 3, the inner surface 124 of the band saw blade 26 has a knurled surface 140. The knurled surface 140 is etched, cut, or otherwise formed onto the inner surface 124 of the band saw blade 26. In the illustrated embodiment, the knurled surface 140 has a diamond pattern. The knurled surface 140 includes a series of grooves 144 and ridges 148. The grooves 144 and ridges 148 provide increased friction and grip between the band saw blade 26 and the wheel tires 86 compared to a band saw blade without a knurled surface on the inner surface. In the illustrated embodiment, the grooves 144 include a first series of straight grooves 152 arranged in parallel to each other, and a second series of straight grooves 154 arranged in parallel to each other. The second series of straight grooves 154 is non-parallel to the first series of straight grooves 152. The ridges 148 formed between the grooves 144 are diamond-shaped. In other embodiments, the grooves 144 may be straight or curved and arranged in other ways, and ribs having other shapes may be formed. In some embodiments, the knurled surface 140 may include other shapes and patterns including, but not limited to, lines angled at forty-five degrees or lines angled at other orientations. In some embodiments, the knurled surface 140 may have a random arrangement of non-patterned shapes and lines or curves; however, in other embodiments, the knurled surface may have a pattern.

The knurled surface 140 extends on the band saw blade 26 from the cut edge 128 to the non-cut edge 132. In some embodiments, the knurled surface 140 may extend only partially on the band saw blade 26 between the cut edge 128 and the non-cut edge 132. In other embodiments, the knurled surface 140 may be located on the inner surface 124 of the band saw blade 26 at various intervals, such that the knurled surface is not a continuous pattern or surface on the band saw blade 26. In still other embodiments, the band saw blade 26 may include a variety of patterns, such that one portion of the blade 26 may include the diamond pattern and another portion of the blade 26 includes another pattern. In yet other embodiments, the band saw blade 26 may include a knurled surface on both the inner surface 124 and the outer surface 120, such that either of the inner surface 124 and the outer surface 120 of the band saw blade 26 may be utilized by a user to provide a desired amount of friction and grip between the band saw blade 26 and the wheel tires 86. The knurled surface on the inner surface 124 may be different from the knurled surface on the outer surface 120. In some embodiments, both the inner surface 124 and the outer surface 120 are knurled similarly for ease of manufacturing. In other embodiments, the knurled surface 140 may be non-uniform in a portion of the band saw blade 26 extending between the cut edge 128 and the non-cut edge 132.

The amount of friction and grip between the inner surface 124 of the band saw blade 26 and the wheel tires 86 increases as the amount of knurled surface 140 increases on the band saw blade 26. Additional friction and grip between the band saw blade 26 and the wheel tires 86 adheres the band saw blade 26 to the wheel tires 86.

Although particular constructions embodying independent aspects of the present invention have been shown and described, other alternative constructions will become apparent to those skilled in the art and are within the intended scope of the independent aspects of the present invention.

What is claimed is:

1. A band saw comprising:
a housing;
a motor supported by the housing;
a first wheel supported by the housing for rotation about a first wheel axis, the first wheel being drivingly coupled to the motor and driveable by the motor;
a second wheel supported by the housing for rotation about a second wheel axis; and
a band saw blade extending around the first wheel and the second wheel for traveling in a continuous loop around the first wheel and the second wheel to cut a work piece, the band saw blade including a first surface for engaging the first wheel and the second wheel, and a second surface opposite the first surface,
wherein the first surface includes a knurled surface for gripping the first wheel and the second wheel.

2. The band saw of claim 1, wherein the first wheel includes a first outer circumferential surface for engaging the band saw blade, the second wheel includes a second outer circumferential surface for engaging the band saw blade, and the inner surface of the band saw blade engages the first and second outer circumferential surfaces.

3. The band saw of claim 1, wherein the knurled surface includes a diamond pattern.

4. The band saw of claim 1, wherein the knurled surface includes a plurality of grooves and a plurality of ridges.

5. The band saw of claim 4, wherein the plurality of grooves includes a first series of grooves arranged in parallel to each other, and a second series of grooves arranged in parallel to each other, wherein the second series of straight grooves is non-parallel to the first series of straight grooves.

6. The band saw of claim 5, wherein the plurality of grooves forms diamond-shaped ridges therebetween.

7. The band saw of claim 1, wherein the band saw blade includes a cut edge having teeth for cutting the workpiece, and a non-cut edge opposite the cut edge, wherein the knurled surface generally extends from the cut edge to the non-cut edge.

8. The band saw of claim 1, wherein at least one of the first and second wheels includes a wheel tire having a circular ring shape and formed of an elastomeric material, the wheel tire engageable with the knurled surface.

9. The band saw of claim 8, wherein the knurled surface includes a first series of straight grooves arranged in parallel to each other,and a second series of straight grooves arranged in parallel to each other, the second series of straight grooves being non-parallel to the first series of straight grooves, and further wherein the plurality of grooves form diamond-shaped ridges therebetween.
